(19) United States
(12) Patent Application Publication
(10) Pub. No.: US 2019/0368762 A1
(43) Pub. Date: Dec. 5, 2019

(54) METHOD AND APPARATUS FOR CONTROLLING AIR CONDITIONER

(71) Applicant: SAMSUNG ELECTRONICS CO., LTD., Suwon-si, Gyeonggi-do (KR)

(72) Inventors: Kyung-Jae KIM, Suwon-si (KR); Kwan-Woo SONG, Yongin-si (KR); Soon-Heum KO, Anyang-si (KR); Gun-Hyuk PARK, Seongnam-si (KR); Sung-Geun SONG, Incheon (KR); Dae-Eun YI, Seoul (KR); Hye-Jung CHO, Anyang-si (KR); Jae-Hong KIM, Yongin-si (KR)

(73) Assignee: Samsung Electronics Co., Ltd., Suwon-si, Gyeonggi-do (KR)

(21) Appl. No.: 16/471,401

(22) PCT Filed: Apr. 20, 2017
(86) PCT No.: PCT/KR2017/004244

§ 371 Date: Jun. 19, 2019

(30) Foreign Application Priority Data
Dec. 23, 2016 (KR) 10-2016-0178465

(51) Int. Cl. F24F 11/46; F24F 11/56; F24F 11/54; F24F 11/64; F24F 11/65; F24F 11/80; G05B 19/042

(52) U.S. Cl. CPC F24F 11/46; F24F 11/56; F24F 11/54; F24F 2120/12; F24F 11/65; F24F 11/80; G05B 19/042; F24F 11/64

(57) ABSTRACT

A method and apparatus for controlling an air conditioner are provided. The method includes generating a dry bulb temperature (DBT) correction map for a space, based on feedback messages received from a plurality of user equipments (UEs), generating a thermal comfort characteristic map for the space, based on temperature measurements included in the feedback messages, determining a setting temperature for the air conditioner in the space, based on the DBT correction map and the thermal comfort characteristic map, and controlling the air conditioner to the determined setting temperature.

### CROSS-REFERENCE TO RELATED APPLICATION(S)

This application is a National Phase Entry of PCT International Application No. PCT/KR2017/004244, which was filed on Apr. 20, 2017, and claims priority to Korean Patent Application No. 10-2016-0178465, which was filed on Dec. 23, 2016, the contents of which are incorporated herein by reference.

### BACKGROUND

### 1. Field

The present disclosure relates to an apparatus and method for controlling an air conditioner based on spatial thermal comfort characteristics.

### 2. Description of the Related Art

The Internet is evolving from a human-oriented connection network in which human beings generate and consume information to the Internet of things (IoT) in which information is transmitted/received and processed between distributed elements such as things. The Internet of everything (IoE) technology is emerging, which combines the IoT with big data processing through connectivity to a cloud server or the like.

For IoT implementation, technologies such as sensing, wired/wireless communication, network infrastructure, service interfacing, and security are required. Recently, techniques including a sensor network for interconnection between things, machine to machine (M2M) communication, and machine type communication (MTC) have been studied.

An intelligent Internet technology (IT) service of creating new values for human livings by collecting and analyzing data generated from interconnected things may be provided in an IoT environment. The IoT may find its applications in a wide range of fields including smart home, smart building, smart city, smart car or connected car, smart grid, health care, smart appliance, and state-of-the art medical service, through convergence between existing IT technologies and various industries.

Buildings such as hotels are equipped with an energy control system to effectively control energy. The energy control system needs to satisfy various requirements such as system requirements, energy saving, and management cost reduction. Particularly, a large building with a plurality of rooms may use a system air conditioner (SAC) for air conditioning. The SAC is comprised of one or more outdoor units and a plurality of indoor units, and a system manager may control temperature settings for the indoor units by means of a centralized control server.

Thermal comfort that a user feels in a building is related to heat sensed by the user. However, rooms of the building may have different spatial thermal comfort characteristics. In other words, even though indoor units are set to the same temperature, operative temperatures that actually affect users may be different in different spaces due to air flows, mean radiant temperatures (MRTs), and dry bulb temperatures (DRTs). Moreover, since different users may feel comfortable in different temperature ranges, there is a need for a technique for efficiently determining and controlling a setting temperature for an SAC in order to keep users comfortable.

The above information is presented as background information only to assist with an understanding of the present disclosure. No determination has been made, and no assertion is made, as to whether any of the above might be applicable as prior art with regard to the present disclosure.

### SUMMARY

An aspect of the present disclosure is to address at least the above-mentioned problems and/or disadvantages and to provide at least the advantages described below. Accordingly, an aspect of the present disclosure is to provide an apparatus and method for controlling an air conditioner with low power.

Another aspect of the present disclosure is to provide an apparatus and method for controlling an air conditioner to keep users thermally comfortable.

Another aspect of the present disclosure is to provide an apparatus and method for controlling an air conditioner based on spatial thermal comfort characteristics.

Another aspect of the present disclosure is to provide an apparatus and method for correcting a temperature measurement of an indoor unit and a dry bulb temperature at the position of a user.

Another aspect of the present disclosure is to provide an apparatus and method for extracting spatial thermal comfort characteristics representing indoor radiant temperature differences among spaces.

Another aspect of the present disclosure is to provide an apparatus and method for determining a setting temperature for an indoor unit in order to keep users thermally comfortable.

In accordance with an aspect of the present disclosure, there is provided a method for controlling an air conditioner. The method includes generating a dry bulb temperature (DBT) correction map for a space, based on feedback messages received from a plurality of user equipments (UEs), generating a thermal comfort characteristic map for the space, based on temperature measurements included in the feedback messages, determining a setting temperature for the air conditioner in the space, based on the DBT correction map and the thermal comfort characteristic map, and controlling the air conditioner to the determined setting temperature.

In accordance with another aspect of the present disclosure, there is provided a server capable of controlling an air conditioner. The server includes a communication unit for receiving feedback messages from a plurality of UEs, each feedback message including at least one of position information, a temperature measurement, and thermal comfort information, receiving a temperature measurement from the air conditioner, and transmitting to the air conditioner information about a setting temperature to control the air conditioner, a controller for generating a DBT correction map for a space based on the position information and the temperature measurements included in the feedback messages, generating a thermal comfort characteristic map for the space based on the position information, the temperature measurements, and the thermal comfort information included in the feedback messages, and determining a setting temperature for the air conditioner in the space, based on the DBT correction map and the thermal comfort characteristic map, and a storage for storing the DBT correction map, the thermal comfort characteristic map, the temperature measurement of the air conditioner, and the setting temperature for the air conditioner.

In accordance with another aspect of the present disclosure, there is provided a method for requesting control of an air conditioner by a UE. The method includes determining position information about a current position of the UE based on received signal strengths of wireless signals received from a plurality of network nodes, acquiring a temperature measurement at the current position through a temperature sensor, receiving thermal comfort information about a user through an input unit, generating a feedback message including the position information, the temperature measurement, and the thermal comfort information, and transmitting the generated feedback message to a server for controlling the air conditioner to control a temperature of a space in which the UE is located.

In accordance with another aspect of the present disclosure, there is provided a UE for requesting control of an air conditioner. The UE includes a sensor unit for acquiring a temperature measurement at a current position, an input unit for receiving thermal comfort information about a user, a controller for determining position information about the current position of the UE, generating a feedback message including the position information, the temperature measurement, and the thermal comfort information, and a communication unit for transmitting the feedback message to a server for controlling the air conditioner to control a temperature of a space in which the UE is located.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF DRAWINGS

The above and other aspects, features and advantages of certain exemplary embodiments of the present disclosure will be more apparent from the following description taken in conjunction with the accompanying drawings, in which:

FIG. 1 illustrates exemplary feedbacks collected in a building to which control of an air conditioner according to various embodiments of the present disclosure is applicable;

FIG. 2 illustrates exemplary mean radiant temperature (MRT) measurements which are applicable to various embodiments of the present disclosure;

FIG. 3 illustrates exemplary maximum comfortable indoor temperatures collected in a building to which control of an air conditioner according to various embodiments of the present disclosure is applicable;

FIG. 4 illustrates an exemplary system for supporting control of an air conditioner according to various embodiments of the present disclosure;

FIG. 5 is a block diagram of a user equipment (UE) according to various embodiments of the present disclosure;

FIG. 6 is a block diagram of a server according to various embodiments of the present disclosure;

FIG. 7 is a diagram illustrating a signal flow for an operation for controlling an air conditioner according to an embodiment of the present disclosure;

FIG. 8 is a flowchart illustrating an operation for controlling an air conditioner by a server according to an embodiment of the present disclosure;

FIG. 9 is a flowchart illustrating an operation for generating a dry bulb temperature correction map according to an embodiment of the present disclosure;

FIG. 10A illustrates an exemplary dry bulb temperature distribution table according to an embodiment of the present disclosure;

FIG. 10B illustrates an exemplary dry bulb temperature correction table according to an embodiment of the present disclosure;

FIG. 11 is a flowchart illustrating an operation for generating a thermal comfort characteristic map according to an embodiment of the present disclosure;

FIG. 12 illustrates an exemplary correction temperature distribution according to an embodiment of the present disclosure;

FIG. 13 illustrates an exemplary thermal comfort characteristic map according to an embodiment of the present disclosure;

FIG. 14 is a flowchart illustrating an operation for determining a setting temperature according to an embodiment of the present disclosure;

FIGS. 15A and 15B illustrate an example of determining a setting temperature by a server according to an embodiment of the present disclosure;

FIG. 16 is a flowchart illustrating an operation for generating a thermal comfort characteristic map in consideration of dissatisfaction feedbacks according to an embodiment of the present disclosure;

FIG. 17 illustrates an exemplary correction temperature distribution according to an embodiment of the present disclosure;

FIG. 18A illustrates MRT characteristics in a theoretical space;

FIG. 18B illustrates MRT characteristics in a real space;

FIGS. 19A and 19B are views describing an operation for estimating an indoor MRT according to an embodiment of the present disclosure;

FIG. 20 illustrates an exemplary reference MRT estimation table according to an embodiment of the present disclosure;

FIG. 21 is a view describing an operation for estimating an indoor MRT based on the presence of electronic devices according to an embodiment of the present disclosure;

FIG. 22 illustrates an exemplary reference MRT estimation table including information about electronic devices according to an embodiment of the present disclosure;

FIG. 23 is a flowchart illustrating an operation for determining a setting temperature in consideration of MRTs according to an embodiment of the present disclosure;

FIGS. 24A and 24B illustrate an example of determining a setting temperature through MRT estimation according to an embodiment of the present disclosure;

FIG. 25 is a flowchart illustrating an operation for controlling an air conditioner using per-individual comfort preferences according to an embodiment of the present disclosure;

FIG. 26 is a flowchart illustrating an operation for extracting individual thermal preferences based on operative temperatures according to an embodiment of the present disclosure;

FIG. 27 is a flowchart illustrating an operation for controlling an air conditioner in consideration of a preferred operative temperature of a user according to an embodiment of the present disclosure; and

FIG. 28 is a flowchart illustrating an operation for controlling an air conditioner in consideration of preferred operative temperatures of a plurality of users according to an embodiment of the present disclosure.

Throughout the drawings, like reference numerals will be understood to refer to like parts, components, and structures.

### DETAILED DESCRIPTION

Reference will be made to embodiments of the present disclosure.

A description of techniques which are known in the technical field of the present disclosure and are not related directly to the present disclosure will be omitted lest it should obscure the subject matter of the present disclosure.

Likewise, some components are exaggerated, omitted, or schematically shown in the attached drawings and the size of each component does not fully reflect its actual size. Like reference numerals denote the same or corresponding components in the drawings.

The advantages and features of the present disclosure, and a method for achieving them will be apparent from the attached drawings and the following detailed description of embodiments. However, the present disclosure may be implemented in various ways, not limited to the following embodiments. Rather, the embodiments are provided to make the present disclosure comprehensive and help those skilled in the art to comprehensively understand the scope of the present disclosure, and the present disclosure is defined only by the appended claims. The same reference numerals denote the same components throughout the specification.

Further, blocks of a flowchart and a combination of flowcharts may be executed by computer program instructions. Since these computer program instructions may be loaded on a processor of a general purpose computer, a special purpose computer, or other programmable data processing equipment, the instructions executed by the processor of the computer or other programmable data processing equipment create means for carrying out functions described in the block(s) of the flowcharts. As the computer program instructions may be stored in a memory usable in a specialized computer or a programmable data processing equipment, or a computer readable memory, it is also possible to create articles of manufacture that carry out functions described in the block diagram(s) of the flowcharts. As the computer program instructions may be loaded on a computer or a programmable data processing equipment, when executed as processes, they may carry out steps of functions described in the block(s) of the flowcharts.

Each block may correspond to a module, a segment or a code containing one or more executable instructions implementing one or more specified logical functions. It is to be noted that in alternative embodiments, it is also possible to execute functions described in blocks in an order different from the listed order. For example, two blocks listed in sequence may be executed substantially at the same time or executed in reverse order according to corresponding functions, when needed.

In the description, the word ‘unit’, ‘module’ or the like may refer to a software component or hardware component such as a field-programmable gate array (FPGA) or application-specific integrated circuit (ASIC). However, ‘unit’ or the like is not limited to hardware or software. A unit or the like may be configured so as to reside in an addressable storage medium or to drive one or more processors. Therefore, units or the like may refer to components such as software components, object-oriented software components, class components, and task components, processes, functions, attributes, procedures, subroutines, program code segments, drivers, firmware, microcode, circuits, data, databases, data structures, tables, arrays, and variables. A function provided by a component and ‘unit’ may be a combination of smaller components and ‘units’, and may be combined with others to compose large components and units. Components and units may be configured to drive a device, or one or more central processing units (CPUs) in a secure multimedia card.

While a specific system and signal standard may be used or mentioned in the following detailed description of embodiments of the present disclosure, those skilled in the art will appreciate that the subject matter of the present disclosure is applicable to other systems and services having similar technical backgrounds without departing from the scope and spirit of the present disclosure.

According to various embodiments of the present disclosure, a user equipment (UE) is an electronic device equipped with communication functionality, which is able to determine the current position of a user carrying the UE and measure a temperature (for example, a dry bulb temperature (DBT)) at the current position. Electronic devices may be classified into, for example, a portable type, a wearable type, and so on.

The portable electronic device may be at least one of, not limited to, for example, a smartphone, a tablet personal computer (PC), a mobile phone, a video phone, an e-Book reader, a personal digital assistant (PDA), a portable multimedia player (PMP), an MP3 player, a mobile medical equipment, an electronic dictionary, an electronic key, a camcorder, or a camera.

The wearable electronic device may be at least one of, not limited to, for example, an accessory type (for example, a watch, a ring, a bracelet, an ankle bracelet, a necklace, glasses, contact lenses, or a head-mounted device (HMD)), a fabric or clothes type (for example, electronic clothes or a sports wear), an attached type (for example, a skin pad or a tattoo), or an implantable type (for example, an implantable circuit).

According to various embodiments, an electronic device may be one or a combination of two or more of the foregoing devices. In an embodiment, an electronic device may be a flexible electronic device. In addition, it will be apparent to one having ordinary skill in the art that an electronic device according to an embodiment of the present disclosure is not limited to the foregoing devices, and may be a new electronic device produced along with technology development.

The definitions of terms as used in various embodiments of the present disclosure are given, as follows.
System air conditioner (SAC): the SAC includes at least one outdoor unit, a plurality of indoor units, and a centralized control server. The air of a building or region in which the SAC is installed is controlled by controlling temperature settings of the indoor units through the centralized control server. The centralized control server may be referred to shortly as ‘server’.
Space: an area affected by control of air conditioning in the SAC. The space may be the whole space of the building in which the SAC is installed or a unit space (referred to simply as ‘space’) affected by each indoor unit. In an embodiment, the space may be defined as a room with an indoor unit. In an embodiment, the space may be defined as an area within a predetermined distance from an indoor unit. In an embodiment, the space may be defined according to the position of at least one nearest indoor unit and the shape of a room in which the indoor unit is deployed.
Dry bulb temperature (DBT): a temperature measured by a sensor unit of a thermometer exposed to the air but shielded from radiation. The DBT means a temperature (an air temperature) indicated by a general thermometer.
Temperature measurement: a DBT measured by means of a UE or an indoor unit.
Feedback: information related to thermal comfort transmitted from a UE to a server. The feedback may include at least one of a temperature measured or determined by a UE, thermal comfort information, and position information. In an embodiment, for the feedback, a feedback message including thermal comfort information produced based on information about thermal comfort input directly by a user, position information, and temperature measurement information may be generated and transmitted to the server. In another embodiment, the UE may measure a temperature and a position periodically (for example, once or twice per hour) without a user input, automatically generate a feedback message including information about the temperature measurement and the position, and transmit the feedback message to the server. In another embodiment, in the absence of a thermal comfort-related input from the user for a predetermined time period (for example, one hour), the UE may automatically generate a feedback message including thermal comfort information (satisfaction), position information, and temperature measurement information, and transmit the feedback message to the server, determining that the user is satisfied with a current temperature.
Thermal comfort information: information indicating thermal comfort received from the user by the UE. For example, the thermal comfort information may indicate at least one of satisfaction, dissatisfaction (hot), and dissatisfaction (cold). Each feedback may be classified as a satisfaction feedback, a dissatisfaction (hot) feedback, or a dissatisfaction (cold) feedback according to the degree of thermal comfort included in the feedback. According to some embodiments, the user may not input the satisfaction feedback directly. Rather, if there is no dissatisfaction feedback from the user for a predetermined time, the UE may automatically generate the satisfaction feedback, determining that the user is satisfied. For example, in the absence of a dissatisfaction feedback (hot or cold) for a predetermined time (for example, one hour) from at least one user in the same space during running an indoor unit at a specific setting temperature (for example, 25 degrees (° C.)), the UE may generate a dissatisfaction feedback, determining that the user is satisfied with the setting temperature.
DBT distribution table: a table listing temperature measurements collected from one space and positions at which the temperatures are measured.
DBT correction map: graphic data in the form of a map on which DBT differences are marked two-dimensionally according to distances from an indoor unit, for use in correcting the difference between a DBT measured at the indoor unit and a temperature (DBT) measured at the UE. For example, the DBT correction map may be laid out by calculating the average of temperatures (DBTs) received from UEs in each of zones defined according to specific radiuses from the indoor unit (for example, 1 m (meter), 2 m, 3 m, . . . ), comparing the average temperatures of the zones with a DBT measured at the indoor unit, and displaying the differences between the average temperatures and the DBT of the indoor unit according to the radiuses from the indoor unit on a two-dimensional (2D) map. For example, if a temperature measured at the indoor unit is 24 degrees and the average of temperature measurements received from a plurality of UEs in a first donut-shaped zone having a radius equal to or larger than 1 m and smaller than 2 m from the indoor unit is 25 degrees, a DBT correction value for the first zone may be −1 degree (this means that the temperature of the first zone becomes equal to the actual setting temperature (24 degrees) by lowering the setting temperature by 1 degree), and the DBT correction map may be generated in such a manner that 0 degree may be marked in a zone within 1 m from the indoor unit and −1 degree may be marked in the first zone.
Correction temperature: the average of temperature measurements within a predetermined distance from a position. In an embodiment, if the maximum of distances between measurement positions of a plurality of feedbacks received from a plurality of UEs is less than a predetermined threshold (for example, 3 m), centroid coordinates may be calculated for the measurement positions, the average of the measured temperatures at the measurement positions may be calculated, the centroid coordinates may be determined to be a representative position, and the average temperature may be determined to be a correction temperature at the representative position.
Correction temperature distribution map: a 2D map on which correction temperatures for a plurality of positions in one space are indicated.
Thermal comfort characteristic map: a map indicating relative values of correction temperatures for temperature measurements included in feedbacks having the same thermal comfort information and positions corresponding to the relative values. The thermal comfort characteristic map indicates a distribution of the positions of relative temperature values representing radiation differences in one space. Each correction temperature means the average of temperature measurements within a predetermined distance from a position, and each relative value means the difference between a correction temperature and a maximum correction temperature in the same space. In an embodiment, the thermal comfort characteristic map may be represented as a spatial thermal comfort characteristic table that stores relative values corresponding to positions.
Setting temperature: a temperature set for an indoor unit by the server. The present disclosure provides various embodiments of determining a setting temperature in a manner that saves energy, while satisfying as much thermal comfort of users as possible.
Desired setting temperature: a setting temperature (a DBT) for an indoor unit, determined by a manager. A setting temperature for the indoor unit may be determined in consideration of the desired setting temperature, the thermal comfort characteristic map, the DBT correction map, and other later-described parameters.
Desired temperature: a desired DBT to be achieved at each position in a space. The desired temperature may be obtained by applying a per-position relative value of the thermal comfort characteristics map to the desired setting temperature. In an embodiment, the desired temperature may be determined by subtracting a relative temperature value corresponding to the position of an indoor unit on the thermal comfort characteristic map from the desired setting temperature.
Setting temperature distribution map: it is generated by applying per-position relative values on the DBT correction map to the desired temperature, indicating per-zone setting temperatures based on the position of the indoor unit. In an embodiment, a setting temperature for the indoor unit may be determined based on an area corresponding to each temperature range and temperature values on the setting temperature distribution map.
Reference mean radiant temperature (MRT) estimation table: a table listing MRT estimates corresponding to DBTs in a space. The server may collect DBT measurements and MRT measurements in a space while the indoor unit is off, and generate a reference MRT estimation table indicating MRT values corresponding to DBT variances. To reflect the influence of the types and number of electronic devices in the space on MRTs, the reference MRT estimation table may further include information about the types and number of electronic devices in the space. The reference MRT estimation table may be used in estimating MRTs based on DBT measurements.
Thermal comfort range: personal thermal comfort information indicating a range defined by upper and lower limits of temperatures at which users feel thermally comfortable. In some embodiments, the thermal comfort range may be determined to be a temperature range from 23 to 25 degrees. If a temperature measurement falls within the temperature range, this may imply that a user is located in the thermal comfort range.
Operative temperature: a thermal comfort index reflecting a DBT, an MRT, and the influence of an air flow comprehensively. The operative temperature may be used as an objective temperature index for thermal comfort that a user actually feels in a specific DBT situation, which reflects the influence of various air flows and an MRT.

In various embodiments of the present disclosure, control of an air conditioner based on spatial thermal comfort characteristics to keep a user thermally comfortable will be described below.

In another of the various embodiments of the present disclosure, it is proposed that MRTs are estimated according to DBT measurements in a space, and an air conditioner is controlled using the estimated MRTs.

In another of the various embodiments of the present disclosure, it is proposed that a setting temperature is controlled in consideration of personal thermal comfort by mapping feedbacks including thermal comfort information collected from users to operative temperatures.

With reference to the attached drawings, an air conditioner control system according to various embodiments will be described. In the present disclosure, the term ‘user’ may cover any person or electronic device (for example, an artificial intelligent electronic device) that uses an electronic device.

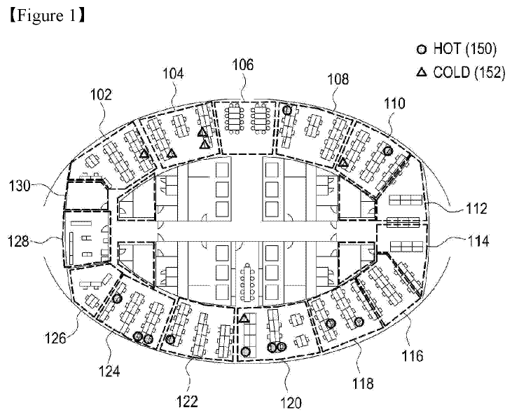

FIG. 1 illustrates exemplary feedbacks collected in a building to which control of an air conditioner according to various embodiments of the present disclosure is applicable.

Referring to FIG. 1, the building may include a plurality of rooms 102, 104, 106, 108, 110, 112, 114, 116, 118, 120, 124, 126, 128, and 130, and one or more indoor units (not shown) may be located in each room. Reference numerals 150 and 152 denote thermal comfort-related feedbacks collected from users in the rooms 102, 104, 106, 108, 110, 112, 114, 116, 118, 120, 124, 126, 128, and 130, while the indoor units are running so that all of the setting temperatures of the rooms 102, 104, 106, 108, 110, 112, 114, 116, 118, 120, 124, 126, 128, and 130 may become equal, for example, 24 degrees. Circles denoted by reference numeral 150 are marked at positions at which dissatisfaction (hot) feedbacks have been generated, and triangles denoted by reference numeral 152 are marked at positions at which dissatisfaction (cold) feedbacks have been generated.

Even though all rooms are managed at the same setting temperature, different feedbacks, that is, the dissatisfaction (hot) feedbacks 150 and the dissatisfaction (cold) feedback 152 may be produced in the same room, as illustrated in FIG. 1.

A thermal feeling (that is, thermal comfort) that a human being feels indoors is affected by environmental factors (temperature, humidity, an MRT, and an air flow velocity) and subjective factors (age, gender, and clothes). A temperature range reflecting these factors in which a plurality of persons feel comfortable is defined as a thermal comfort range.

Among the factors, the MRT represents a condition for the radiant heat of surrounding walls and facilities in a limited space. That is, the MRT means the average of the temperatures of surrounding surfaces which exchange heat with human bodies by radiation. For example, in spite of the same indoor temperature, it feels hotter near to the ceiling in summer, and colder near to a window in winter due to the effect of surface temperature-based radiation. Since an indoor surface is irregular and the area of a surface to which a human body is exposed varies according to an indoor position, the MRT is calculated to be the average of the temperatures of indoor surfaces such as a wall surface, a ceiling surface, and a floor surface, for the convenience.

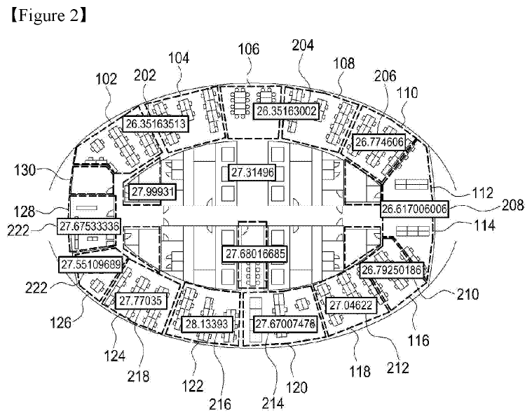

FIG. 2 illustrates exemplary MRT measurements which are applicable to various embodiments of the present disclosure.

Referring to FIG. 2, reference numerals 202, 204, 206, 208, 210, 212, 214, 216, 218, 220, and 222 denote average MRTs measured at specific positions in the rooms 102, 104, 106, 108, 110, 112, 114, 116, 118, 120, 122, 124, 126, 128, and 130 by MRT simulation for one month. As noted from FIG. 2, south-facing rooms 116, 118, 120, 122, 124, 126, and 128 and center rooms may have high MRTs relative to the other rooms. In other words, different MRTs result according to the positions and directions of rooms.

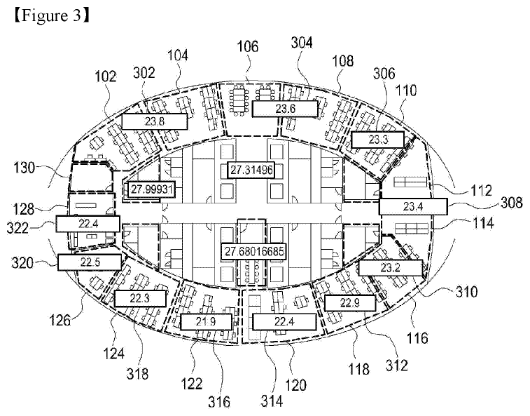

FIG. 3 illustrates exemplary maximum comfortable indoor temperatures collected in a building to which control of an air conditioner according to various embodiments of the present disclosure is applicable.

Referring to FIG. 3, reference numerals 302, 304, 306, 308, 310, 312, 314, 316, 318, 320, and 322 denote indoor temperature measurements that offer maximum satisfaction at specific positions in the rooms 102, 104, 106, 108, 110, 112, 114, 116, 118, 120, 124, 126, 128, and 130. As noted from FIG. 3, even though indoor units are running for the same setting temperature, each space has a different indoor temperature measurement according to the MRTs 202, 204, 206, 208, 210, 212, 214, 216, 218, 220, and 222.

An operative temperature (which determines thermal comfort) that users actually feel in a building is determined by an MRT and a DBT. It is difficult to measure an MRT because it involves all devices and objects. That is, the MRT may be changed by electronic devices such as a monitor, a computer, and a light, as well as sunlight, wall surfaces, a ceiling, and a floor. The MRT may further be changed in the passage of time, that is, according to a change in the intensity and direction of sunlight when the sun rises and sets.

In the following various embodiments, a setting temperature may be determined for an SAC by reflecting spatial thermal comfort characteristics including MRTs in order to keep users thermally comfortable.

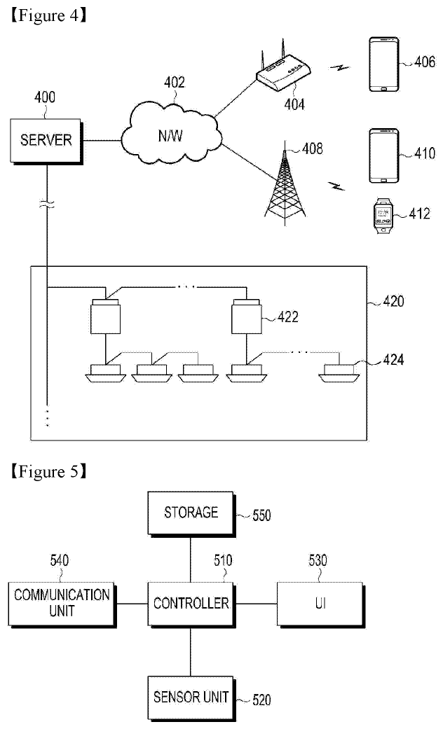

FIG. 4 illustrates an exemplary system for supporting control of an air conditioner according to various embodiments of the present disclosure.

Referring to FIG. 4, the system for supporting control of an air conditioner may include a server 400 and an air conditioner 420. The air conditioner 420 may include at least one outdoor unit 422, and a plurality of indoor units 424. The server 400 collects temperature measurements from the plurality of indoor units 424 and controls a setting temperature for the indoor units 424. The indoor units 424 transfer heat introduced by the outdoor unit 422 into a house according to the setting temperature (heating) or discharge heat from the inside to the outside according to the setting temperature (cooling). In the present disclosure, illustration of other components of the SAC which are not related much to embodiments of the present disclosure will be avoided, and it is apparent that the illustration does not limit what the present disclosure is intended to claim.

The server 400 may have communication functionality that allows access of UEs 406, 410, and 412 through a network (N/W) 402. For example, the UE 406 may communicate with the server 400 through an access point (AP) 404 by wireless fidelity (WiFi). For example, the UEs 410 and 412 may communicate with the server 400 through a base station (BS) 408 by broadband communication.

The server 400 determines and manages a setting temperature for each of the indoor units 424 in consideration of temperature measurements collected from the indoor units 424 and feedbacks received from the UEs 406, 410, and 412. Additionally, the server 400 may further receive sensing data collected from temperature sensors, air flow sensors, and humidity sensors located indoors and use the received sensing data in determining the setting temperature. The server 400 may transmit a temperature control command including the determined setting temperature to an intended indoor unit 424. The temperature control command may be transmitted to the indoor unit 424 wiredly or wirelessly, for example, by WiFi, Bluetooth with low energy (BLE), Zigbee, ZigWave, or cellular communication (3-rd generation/4-th generation/5-th generation (3G/4G/5G)).

The server 400 may be configured so as to store temperature measurements collected from the indoor units 424, feedbacks received from the UEs 406, 410, and 412, and setting temperatures determined for the indoor units 424, and display the temperature measurements, the feedbacks, and the setting temperatures on a display. Further, the server 400 may collect and store position information about the indoor units 424.

FIG. 5 is a block diagram of a UE according to various embodiments of the present disclosure.

Referring to FIG. 5, the UE 406, 410, or 412 may include a controller 510, a sensor unit 520, a user interface (UI) 530, a communication unit 540, and a storage 550.

The communication unit 540 may communicate with an external device (for example, the server 400) in at least one communication scheme supported by the UE 406, 410, or 412. The communication unit 540 may receive a network signal from one or more wireless signal devices under the control of the controller 510, and estimate its position using the strength of the network signal. The communication unit 540 may provide position information indicating the estimated current position of the UE 406, 410, or 412 or received position information to the server 400 under the control of the controller 510.

The communication unit 540 may provide a thermal comfort-related feedback to the server 400 under the control of the controller 510. The communication unit 540 may provide a temperature measurement-related feedback to the server 400 under the control of the controller 510. The communication unit 540 may receive from the server 400 information related to control of an air conditioner, for example, information about a setting temperature for an indoor unit in a space in which the UE 406, 410, or 412 is located, and a DBT correction map, a thermal comfort characteristic map, and information about per-individual thermal comfort ranges which are generated based on feedbacks by the server 400. The communication unit 540 may transmit a temperature control request to the server 400 under the control of the controller 510.

The UI 530 may output necessary information to a user under the control of the controller 510 or provide information received from the user to the controller 510. For example, the UI 530 may receive thermal comfort information (indicating, for example, satisfaction or dissatisfaction (hot or cold)) from the user and provide the received thermal comfort information to the controller 510. The UI 530 may include a display (not shown) configurable as a touch screen. The display may display information about a space in which a user is located and information related to control of an air conditioner under the control of the controller 510. In an embodiment, the display may display the received thermal comfort information. In an embodiment, the display may display information about a space in which a user is located (for example, a layout of the space) and display temperature measurements collected through the sensor unit 520 and a setting temperature determined by the server 400 on the displayed space information, under the control of the controller 510. In an embodiment, the display may display UI information (for example, a menu) for requesting display of a DBT correction map and a thermal comfort characteristic map generated by the sever 400, receive a user input (a touch input) requesting display of the DBT correction map, the thermal comfort characteristic map, or a thermal comfort range for a user through the UI information, and notify the controller 510 of the user input. The display may display the DBT correction map, the thermal comfort characteristic map, or the information about the thermal comfort range received from the server 400 under the control of the controller 510.

The sensor unit 520 may include various types of sensors for sensing context information. The sensor unit 520 may include at least one of, for example, a temperature sensor, an air flow sensor, and a humidity sensor, and provide sensing data received from the sensor to the controller 510. The sensor unit 520 may further include, for example, a GPS and/or a gyro sensor for determining the current position of the UE 406, 410, or 412 and provide sensing data received from the GPS and/or gyro sensor to the controller 510.

The controller 510 may configure a feedback including at least one of a temperature measurement, information about a current position, and thermal comfort information of the user based on sensing data collected through the sensor unit 520 and information received from the outside (for example, the user), and transmit the feedback to the server 400 through the communication unit 540 periodically at every predetermined interval (for example, every hour), which should not be construed as limiting the present disclosure. In an embodiment, at a feedback transmission time, if the controller 510 has not received the thermal comfort information of the user through the UI 530 in a previous period, the controller 510 may generate a feedback message including the position information and the temperature measurement without the thermal comfort information and transmit the feedback message periodically. In an embodiment, at a feedback transmission time, if the controller 510 has not received thermal comfort information of the user through the UI 530 in a previous period, the controller 510 may automatically generate thermal comfort information indicating satisfaction, generate a feedback message including the position information, the temperature measurement, and the generated thermal comfort information, and transmit the feedback message periodically.

The controller 510 may configure a temperature control request with the sensing data and received information. The temperature control request may include, for example, information about a desired setting temperature. The controller 510 may transmit the configured feedback and/or temperature control request to the server 400 through the communication unit 540.

The controller 510 may perform a control operation for displaying a setting temperature for the user on the display included in the UI 530, using temperature control information received from the server 540. The controller 510 may perform a control operation for displaying an image of a space in which the user is located on the display, based on space information included in the temperature control information received from the server 540. The space information means information about a place occupied by a human being or an object or a place distinguished from another space by an arbitrary boundary, in which human activities or object movements take place. In an embodiment, the space information may include information about a per-floor layout of equipment and/or furniture, and/or an indoor map.

The controller 510 may control the display to display a setting temperature determined for the user on the displayed space image. The controller 510 may control reception of a process result of the feedback and/or the temperature control request from the server 400 through the communication unit 540 and display of the received process result on the display.

The storage 550 may store thermal comfort information received through the UI 530, sensing data received from the sensor unit 520, and information received from the server 400 through the communication unit 540.

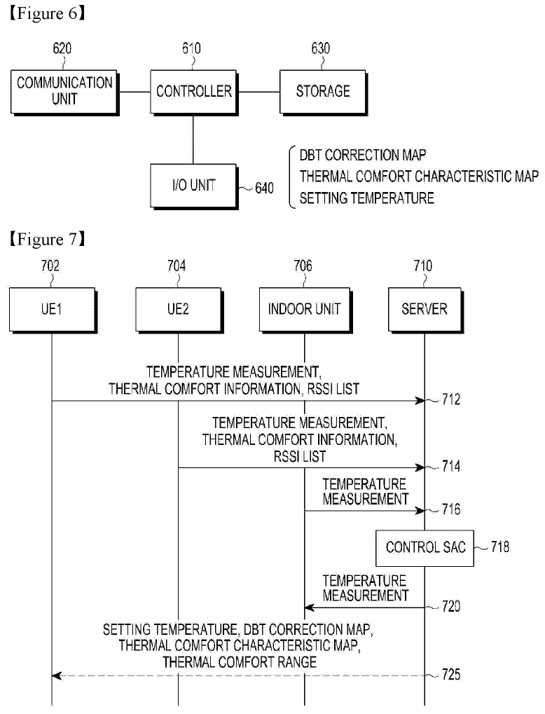

FIG. 6 is a block diagram of a server according to various embodiments of the present disclosure.

Referring to FIG. 6, the server 400 may include a controller 610, a communication unit 620, a storage 630, and an input/output (I/O) unit 640.

The communication unit 620 may communicate with the indoor units 424 and the UEs 406, 410, and 412. For example, the communication unit 620 may receive feedbacks each including a temperature measurement, thermal comfort information, and position information from the UEs 406, 410, and 412 and information about temperature measurements from the indoor units 424 and other temperature sensors, and transmit a temperature control command to the indoor units 424.

The controller 610 may generate a DBT correction map and a thermal comfort characteristic map based on the feedbacks collected through the communication unit 620, and determine a setting temperature for the indoor units 424. The controller 610 may transmit a temperature control command including the determined setting temperature to the indoor units 424 through the communication unit 620. The temperature control command may be transmitted to at least one indoor unit 424 related to control of an air conditioner in each indoor space so as to satisfy thermal comfort of users in the space. The controller 610 may receive information about a desired setting temperature from a manager through a UI (not shown) such as a keyboard or a mouse, and calculate a setting temperature to be actually applied to the indoor units 424 based on the desired setting temperature. The controller 610 may control the communication unit 620 to transmit the DBT correction map and the thermal comfort characteristic map stored in the storage 630 to an intended UE. Further, the controller 610 may determine a thermal comfort range corresponding to a UE using a feedback message received from the UE, and control the communication unit 620 to transmit information about the thermal comfort information to the UE.

The storage 630 may store information about the DBT correction map, the thermal comfort characteristic map, and the setting temperature, for use in determining a setting temperature by the controller 610. The storage 630 may store history information about DBT correction maps, thermal comfort characteristic maps, and setting temperatures for a predetermined time period, and provide stored information under the control of the controller 610.

The I/O unit 640 includes a display for displaying information related to determination of a setting temperature under the control of the controller 610 and an input unit for receiving information about a desired temperature and providing the received information about the desired temperature to the controller 610. In an embodiment, the display may display a DBT correction map and a thermal comfort characteristic map which are generated by the controller 610, a setting temperature for each indoor unit, and a desired setting temperature for controlling a specific space to a desired temperature. The controller 610 may display, on the display, one DBT correction map corresponding to a time zone to which a current time belongs or a time zone closest to the current time from among DBT correction maps for respective time zones stored in the storage 630. The time zones may be classified, for example, on a time basis (morning, afternoon, and evening) or on a season basis (winter time and summer time). Each time zone may span, for example, one or two hours.

FIG. 7 is a diagram illustrating a signal flow for an operation for controlling an air conditioner according to an embodiment of the present disclosure.

Referring to FIG. 7, first and second UEs (UE1 and UE2) 702 and 704 transmit feedbacks each including at least one of a temperature measurement, thermal comfort information, and position information to a server 710 in operations 712 and 714. The position information may be, for example, identification information about at least one network node sensed by the communication unit 540 and a list of the received signal strengths (for example, received signal strength indicators (RRSIs)) of signals from the at least one network node (hereinafter, referred to as an RSSI list). The network node may be, for example, the AP 404, the BS 407, a router, or a gateway. In another example, the position information may be a latitude/longitude sensed by a GPS. In the illustrated case, each feedback includes an RSSI list.

In operation 716, the server 710 may collect temperature measurements from indoor units 706 and other temperature sensors (not shown).

In operation 718, the server 710 calculates setting temperatures based on the information collected in operations 712, 714, and 716 to control indoor units of an SAC. In an embodiment, the server 710 may select at least one indoor unit which is nearest to UE1 702 and UE2 704 or which is capable of offering excellent temperature control performance relative to the other indoor units with respect to the positions of UE1 702 and UE2 704, and determine a setting temperature for the indoor unit using the collected feedbacks and temperature measurements received from the indoor unit. In operation 720, the calculated setting temperatures are transmitted in temperature control commands to the indoor units 706. Operation 718 will be described in detail in the following embodiments. In operation 720 which is optional, the server 710 may provide UE1 702 and UE2 704 with the determined setting temperatures, and a DBT correction map, a thermal comfort characteristic map, and/or information about a thermal comfort range, which has been used in determining the setting temperatures. UE1 702 and UE2 704 may display the received information upon user request or automatically.

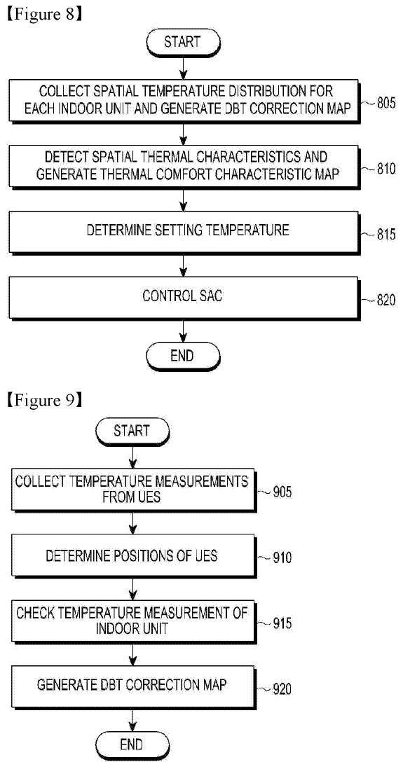

FIG. 8 is a flowchart illustrating an operation for controlling an air conditioner by a server according to an embodiment of the present disclosure.

Referring to FIG. 8, the server generates a DBT distribution table based on temperature measurements and position information received from UEs in a space in which indoor units to be controlled are located, and generates a DBT correction map using the DBT distribution table and information about a map of the space in operation 805. The DBT distribution table lists temperature measurements collected from the UEs (and other temperature sensors) located indoors, and positions at which the temperature measurements have been sensed. The DBT correction map indicates correction values for the temperature measurements collected in the single space and the positions corresponding to the correction values. A specific embodiment for generating a DBT correction map will be described later.

In operation 810, the server generates a thermal comfort characteristic map representing spatial thermal comfort characteristics of the space to be controlled, based on thermal comfort information and temperature measurements included in feedbacks collected from UEs. The thermal comfort characteristic map indicates relative values of correction temperatures for temperature measurements included in feedbacks having the same thermal comfort information, defining radiation differences in the space. The relative values define spatial thermal characteristics, affecting setting temperature differences according to spaces. Each correction temperature may be calculated to be the average of temperature measurements within a predetermined distance from a position. Each relative value may be calculated to be the difference between a correction temperature and a maximum correction temperature in the same space. A specific embodiment for generating a thermal comfort characteristic map will be described later.

In operation 815, the server determines a setting temperature for each indoor unit of an SAC based on the DBT correction map and the thermal characteristic map. The setting temperature may be calculated by determining a setting temperature distribution through application of the thermal comfort characteristic map to a predetermined desired setting temperature, and applying the DBT correction map to the setting temperature distribution. Specifically, a setting temperature for a specific indoor unit is determined by correcting the setting temperature distribution through application of the setting temperature distribution to the DBT correction map and calculating an average of the corrected temperatures in consideration of per-temperature areas. A specific embodiment for determining a setting temperature will be described later.

In operation 820, the server controls the indoor unit by transmitting a temperature control command including the determined setting temperature to the indoor unit. Herein, at least one temperature control command may be transmitted to at least one indoor unit requiring control among a plurality of indoor units in the SAC.

FIG. 9 is a flowchart illustrating operation 805 for generating a DBT correction map according to an embodiment of the present disclosure.

Referring to FIG. 9, the server checks temperature measurements collected from UEs (and other temperature sensors) in operation 905, and determines positions at which the temperature measurements have been detected in operation 910. For example, the UEs (and other temperature sensors) may report feedbacks including temperature measurements and position information to the server, periodically at every predetermined interval. The server may use the average of temperature measurements collected during a predetermined time period, or a latest collected temperature measurement. The positions may be determined by the strengths of network signals sensed by the UEs (and other temperature sensors) and identification information about network nodes that have transmitted the network signals.

In operation 915, the server checks a temperature measurement sensed by an indoor unit covering a space to be controlled. The server generates a DBT correction map based on the checked information in operation 920. In an embodiment, the server may use a DBT distribution table to generate the DBT correction map. The DBT distribution table includes temperature measurements and positions corresponding to the temperature measurements, and the DBT correction map indicates relative values of the temperature measurements and the positions corresponding to the relative values in zones defined according to a plurality of radiuses from the position of the indoor unit. The generated DBT distribution table and the DBT correction map are stored by space in the storage of the server. In an embodiment, the server may receive feedback messages including temperature measurements from UEs, classify the feedback messages according to time zones, and independently generate a DBT correction map per time zone, using position information and temperature measurements received at times within the same time zone (for example, 9 AM to 12 PM or 12 PM to 14 PM).

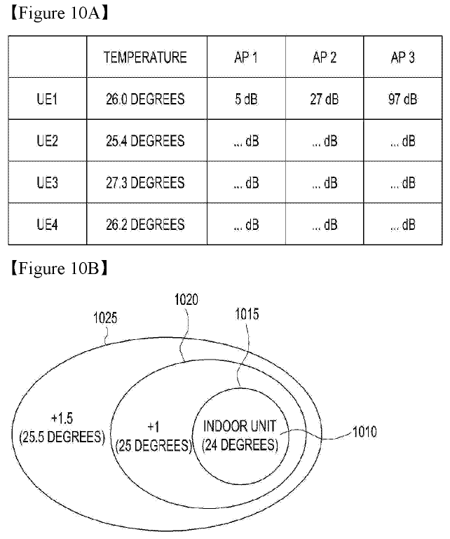

FIG. 10A illustrates an exemplary DBT distribution table according to an embodiment of the present disclosure.

Referring to FIG. 10A, in the DBT distribution table, the first column represents identification information about UEs, the second column represents temperature measurements sensed by the UEs, and the third, fourth, and fifth columns represent the strengths of signals from APs, sensed by the UEs. The server may pre-store position information about the APs and estimate the positions of the UEs based on the signal strengths of the APs, which should not be construed as limiting the present disclosure. Therefore, the third, fourth, and fifth columns correspond to position information about the UEs. For example, it may be noted from the DBT distribution table that UE1 is nearest to AP3 and located in a place where UE1 may sense signals from AP1 and AP2.

While not shown, the server may estimate the positions of the UEs based on the signal strengths of the APs included in feedbacks received from the UEs, and include information (for example, latitudes/longitudes/altitudes) indicating the estimated positions in the DBT distribution table, instead of the third, fourth, and fifth columns.

FIG. 10B illustrates an exemplary DBT correction map according to an embodiment of the present disclosure.

Referring to FIG. 10B, the DBT correction map is generated based on the DBT distribution table illustrated in FIG. 10A. As illustrated in FIG. 10B, the DBT correction map with a specific indoor unit 1010 as a reference indicates a first zone 1015 within a first radius (for example, 1 m) including the position of the indoor unit 1010, a second zone 1020 within a second radius (for example, 1 to 2 m) except the first zone 1015, and a third zone 1025 within a third radius (for example, 2 to 3 m) except the second zone 1020, with respect to a temperature of 24 degrees measured at the indoor unit 1010. While not shown, at least one zone may further be defined next to the third zone 1025 according to collected temperature measurements. Each zone is defined according to a correction value being a temperature difference from the reference temperature (that is, the temperature measured at the indoor unit). In the illustrated example, the average temperature measurement of the second zone 1020 is 25 degrees and thus the correction value of the second zone 1020 is +1. The average temperature measurement of the third zone 1025 is 25.5 degrees and thus the correction value of the third zone 1025 is +1.5. The radius and temperature range of each zone may be predetermined by the server.

In an embodiment, the server may calculate the average temperature measurement of the whole space in consideration of the areas of the zones 1015, 1020, and 1025.

For example, if the area of the first zone 1015 is A1, the area of the second zone 1020 is A2, and the area of the third zone 1025 is A3, the average temperature measurement of the space may be calculated by (A3×25.5+A2×25+A3×24)/(A1+A2+A3).

In an embodiment, the server may calculate the average correction value of the whole space in consideration of the areas of the zones 1015, 1020, and 1025.

For example, if the correction value of the first zone 1015 is a, the correction value of the second zone 1020 is b, and the correction value of the third zone 1025 is c, the average correction value of the space may be calculated by (A3×a1+A2×a2+A3×a3)/(A1+A2+A3).

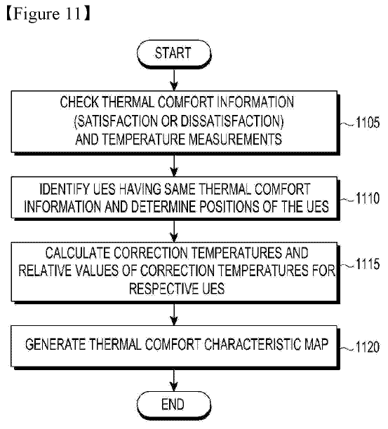

FIG. 11 is a flowchart illustrating an operation for generating a thermal comfort characteristic map according to an embodiment of the present disclosure.

Referring to FIG. 11, the server checks temperature measurements and thermal comfort information included in feedbacks collected from UEs (and other temperature sensors) in operation 1105, and determines the positions of UEs corresponding to feedbacks having the same thermal comfort information in operation 1110. For example, the server may use temperature measurements included in dissatisfaction (cold) feedbacks. In another example, the server may use temperature measurements included in dissatisfaction (hot) feedbacks.

In operation 1115, relative values of correction temperatures for the temperature measurements are calculated. Each correction temperature may be calculated to be the average of temperature measurements within a predetermined distance (for example, 3 m) from a position. The coordinates of a representative position for the correction temperatures may be defined as colloid coordinates of the coordinates of positions corresponding to all temperature measurements. The predetermined distance may be defined to be, for example, ½ of a standard interval between indoor units (or an average installation interval between the indoor units). In some embodiments, the server may calculate the averages of temperature measurements within predetermined distances from an indoor unit, and determine the average of temperature measurements in each zone defined according to a distance from the indoor unit to be a correction temperature for the zone. The correction temperatures are used to determine the average of temperatures in a space covered by the single indoor unit. Each relative value may be calculated to be the difference between a correction temperature and a reference temperature in the same space. In an embodiment, the reference temperature may be the maximum or minimum of the correction temperatures in the space.

In operation 1120, the server generates a thermal comfort characteristic map representing the relative values and positions corresponding to the relative values. The generated thermal comfort characteristic map is stored by space in the storage of the server.

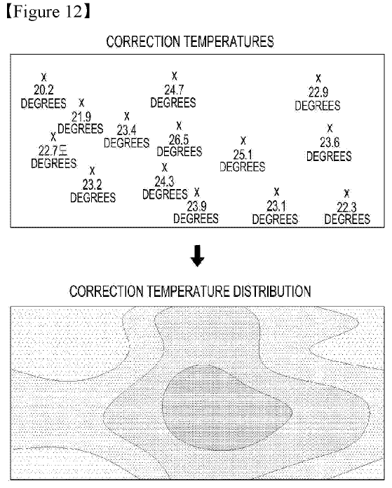

FIG. 12 illustrates an exemplary correction temperature distribution map according to an embodiment of the present disclosure.

Referring to FIG. 12, the correction temperature distribution map indicates, for example, correction temperatures for temperature measurements included in satisfaction feedbacks and positions corresponding to the correction temperatures. In the illustrated example, each correction temperature may be calculated to the average of temperature measurements within a predetermined distance, for example, 3 m from a position at which a corresponding temperature measurement is detected. The predetermined distance is a half of a standard interval (for example, 6 m) between given indoor units of an SAC.

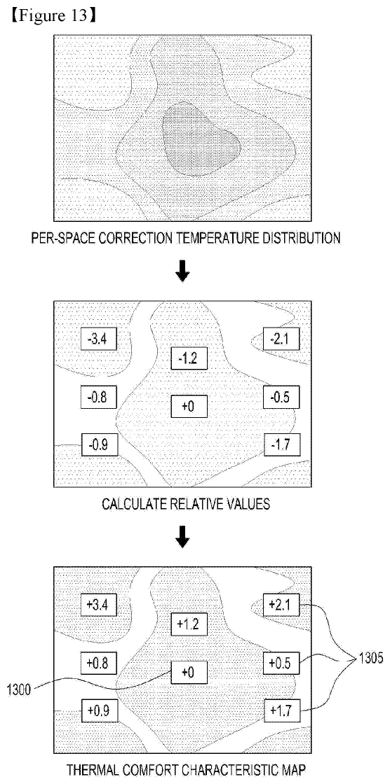

FIG. 13 illustrates an exemplary thermal comfort characteristic map according to an embodiment of the present disclosure.

Referring to FIG. 13, the thermal comfort characteristic map indicates relative values of correction temperatures and positions corresponding to the relative values. A relative value 1300 at the center of the thermal comfort characteristic map corresponds to a reference correction temperature, and the other relative values 1305 mean the differences between the reference correction temperature and correction temperatures at positions corresponding to the other relative values 1305. The reference correction temperature may be, for example, the maximum of the correction temperatures in the space. The relative values 1300 and 1305 of the thermal comfort characteristic map are used to differentiate setting temperatures for indoor units according to spaces, to thereby provide a uniform operative temperature across the spaces.

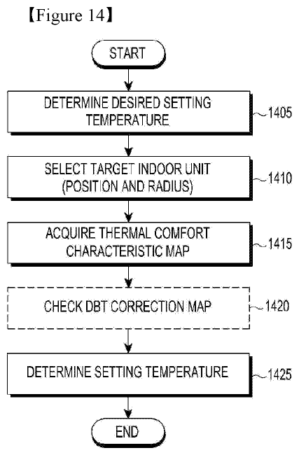

FIG. 14 is a flowchart illustrating operation 815 for determining a setting temperature according to an embodiment of the present disclosure.

Referring to FIG. 14, the server checks a predetermined desired setting temperature or receives a desired setting temperature from a manager in operation 1405, and selects a target indoor unit to be controlled in operation 1410. Once the target indoor unit is selected, the server may determine a space around the indoor unit. In an embodiment, the space may be defined to be within a predetermined distance from the indoor unit. The predetermined distance may be defined as, for example, ½ of a standard interval or an average interval between indoor units.

The server reads a thermal comfort characteristic map for the space corresponding to the target indoor unit from the storage in operation 1415 and a DBT correction map for the space from the storage in operation 1420. In operation 1425, the server determines a setting temperature for the target indoor unit by applying the thermal comfort characteristic map and the DBT correction map to the desired setting temperature. The determined setting temperature may be stored by space in the storage of the server.

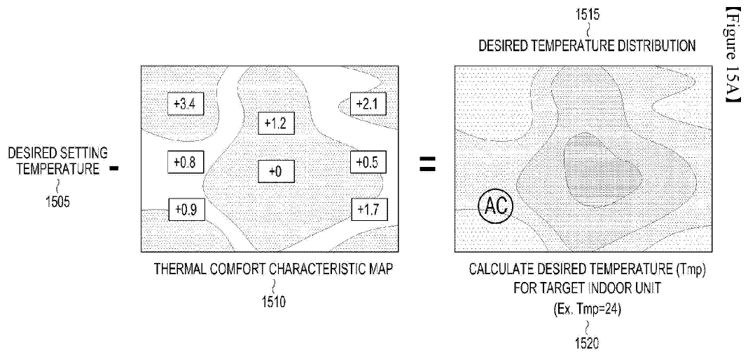

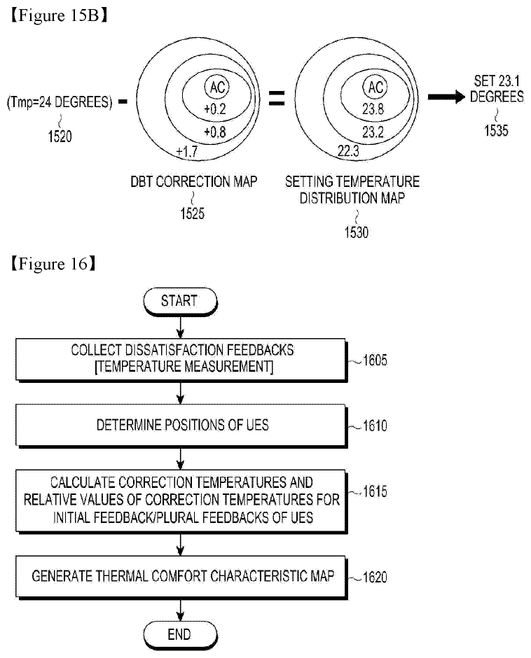

FIGS. 15A and 15B illustrate an example of determining a setting temperature by a server according to an embodiment of the present disclosure.

Referring to FIG. 15A, the server calculates a desired temperature distribution 1515 by subtracting per-position relative values 1510 on a thermal comfort characteristic map from a desired setting temperature 1505. The desired temperature distribution 1515 includes desired temperatures at positions in a space to be controlled. The server may calculate a desired temperature 1520 corresponding to the position of an indoor unit to be controlled based on the desired temperatures in the desired temperature distribution 1515. For example, the desired temperature 1520 may be calculated to be the average of the desired temperatures in the desired temperature distribution 1515. For example, the server may calculate the desired temperature 1520, for example, by interpolating a predetermined number of desired temperatures near to the position of the indoor unit according to distances from the indoor unit.

Referring to FIG. 15B, the server determines a setting temperature distribution map 1530 by subtracting per-zone correction values on a DBT correction map 1525 from the desired temperature 1520. The setting temperature distribution map 1530 represents per-zone setting temperatures with respect to the position of the indoor unit. In the illustrated example, a setting temperature for a first zone nearest to the indoor unit is 23.8 degrees, a setting temperature for a second zone second-nearest to the indoor unit is 23.2 degrees, and a setting temperature for a third zone third-nearest to the indoor unit is 22.3 degrees.

Then, a setting temperature for the indoor unit is finally calculated based on the per-zone setting temperatures.

In an embodiment, the setting temperature for the indoor unit may be calculated to be the average of the per-zone setting temperatures.

In an embodiment, the server may finally calculate the setting temperature for the indoor unit in consideration of the areas of the zones included in the setting temperature distribution map 1530.

For example, if the area of the first zone is A1, the area of the second zone is A2, and the area of the third zone is A3, the average temperature measurement of the space may be calculated by (A3×23.8+A2×23.2+A3×22.3)/(A1+A2+A3).

In an embodiment, the server may calculate the setting temperature for the indoor unit directly (without using the setting temperature distribution map) by applying the average correction value of the DBT correction map 1525 to the desired temperature 1520, instead of individually applying the correction values of the DBT correction map 1525 to the desired temperature 1520.

In the following embodiment, spatial thermal comfort characteristics may be determined based on dissatisfaction feedbacks received from UEs.

FIG. 16 is a flowchart illustrating operation 810 for generating a thermal comfort characteristic map in consideration of dissatisfaction feedbacks according to an embodiment of the present disclosure.

Referring to FIG. 16, the server collects dissatisfaction feedbacks including temperature measurements from UEs (and other temperature sensors) in operation 1605. The dissatisfaction feedbacks may include the same thermal comfort information, for example, dissatisfaction (cold) or dissatisfaction (hot). For example, the server may use an initial dissatisfaction feedback generated from each individual UE. For example, if one user transmits a plurality of dissatisfaction feedbacks from the same position (or similar positions) to the server, a temperature measurement included in the first of the plurality of dissatisfaction feedbacks may be used in generating a thermal comfort characteristic map. In another example, the server may use the average of temperature measurements in a plurality of dissatisfaction feedbacks generated from each individual UE. In some embodiments, the server may classify a plurality of feedbacks generated during a predetermined time period (for example, one hour) according to their reception times, identify the same type of feedbacks (satisfaction, dissatisfaction (cold), or dissatisfaction (hot)) for the specific time period, and independently generate a thermal comfort characteristic map for the time period. In an embodiment, if receiving a plurality of feedback messages including thermal comfort information indicating dissatisfaction (hot) from the same UE, the server determines an upper limit of a thermal comfort range for the UE, using the first received feedback message. In an embodiment, if receiving a plurality of feedback messages including thermal comfort information indicating dissatisfaction (cold) from the same UE, the server determines a lower limit of a thermal comfort range for the UE, using the first received feedback message.

In operation 1610, the server determines the positions of the UEs that have generated the dissatisfaction feedbacks. The positions of the UEs may be determined based on, for example, network node identification information and RSSIs included in the dissatisfaction feedbacks.

In operation 1615, the server calculates relative values of correction temperatures for temperature measurements included in the dissatisfaction feedbacks. The server generates a thermal comfort characteristic map indicating the calculated relative values and positions corresponding to the relative values in operation 1620.

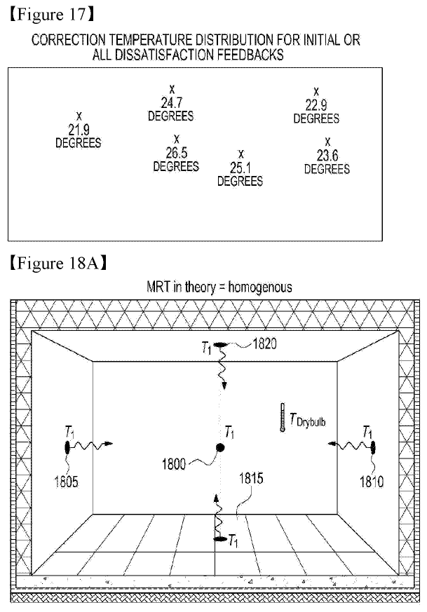

FIG. 17 illustrates an exemplary correction temperature distribution according to an embodiment of the present disclosure.

Referring to FIG. 17, the illustrated correction temperature distribution indicates correction temperatures corresponding to dissatisfaction (hot) feedbacks and positions corresponding to the correction temperatures. In the illustrated example, each correction temperature may be calculated to be the average of temperature measurements within a predetermined distance, for example, 3 m from a position at which a temperature measurement is detected.

In the following embodiments, operations for determining a setting temperature for an SAC in consideration of MRT characteristics in a space are provided.

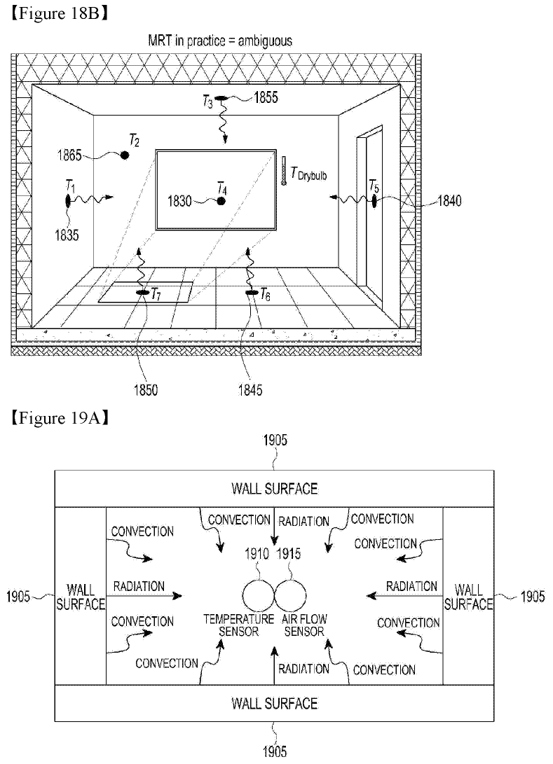

FIG. 18A illustrates MRT characteristics in a theoretical space, and FIG. 18B illustrates MRT characteristics in a real space.

As illustrated in FIG. 18A, in an ideal space where the surface temperatures 1805, 1810, 1815, and 1820 of all walls are equal, T₁, an MRT 1800 is easily calculated using the surface temperatures of the walls (T_{MRT}=T₁).

As illustrated in FIG. 18B, the surface temperatures 1835, 1840, 1845, 1850, and 1855 of walls are different T₁, T₂, T₃, T₄, and T₅ in a real space. Due to the various surface temperatures and many factors such as windows, electronic devices, and doors, an MRT 1830 of the space is difficult to calculate.

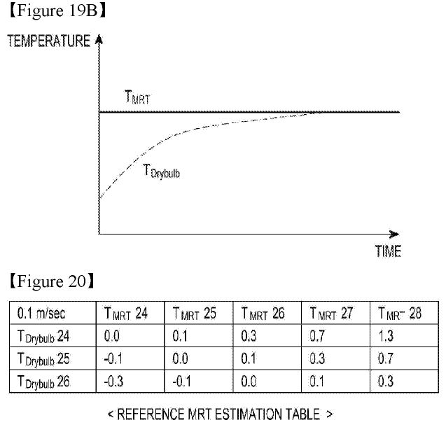

FIGS. 19A and 19B are views depicting an operation for estimating an indoor MRT according to an embodiment of the present disclosure.

Because heat is transferred from a high-temperature area to a low-temperature area, DBTs and wall surface temperatures in a space surrounded by walls 1905 become sufficiently equal over time, as illustrated in FIG. 19A.

Therefore, the DBTs T_{Drybulb} get equal to an MRT T_{MRT} over time, as illustrated in FIG. 19B.

Heat emitted from the wall surfaces 1905 is classified into convective heat and radiant heat. Since a DBT measurable by a temperature sensor 1910 is changed by wall surface convention, a temperature variance may be determined according to wall surface temperatures.

A DBT variance is determined by the difference between T_{Drybulb} and T_{MRT}.

Further, the amount of heat transferred by convection is determined according to the strength of an air flow, and thus an air flow value measured by an air flow sensor 1915 is needed. Therefore, the MRT may be estimated using DBT variances based on air flow strengths.

The server collects DBT measurements and MRT measurements in a space while an indoor unit is off, and generates a reference MRT estimation table listing MRTs corresponding to DBT variances. The reference MRT estimation table may store DBT variances during a predetermined unit time (for example, 1 min) according to DBT measurements, MRTs, and air flows.

FIG. 20 illustrates an exemplary reference MRT estimation table according to an embodiment of the present disclosure.

Referring to FIG. 20, the reference MRT estimation table lists DBT measurements and DBT variance for respective MRT measurements in a space with an air flow strength of 0.1 m/sec. In the illustrated example, if a DBT measurement is 24 degrees and a DBT variance for the latest one minute is 0.3 degrees, the server may estimate the MRT to be 26 degrees. For example, if a DBT measurement is 26 degrees and a DBT variance for the latest one minute is −0.3 degrees, the server may estimate the MRT to be 24 degrees.

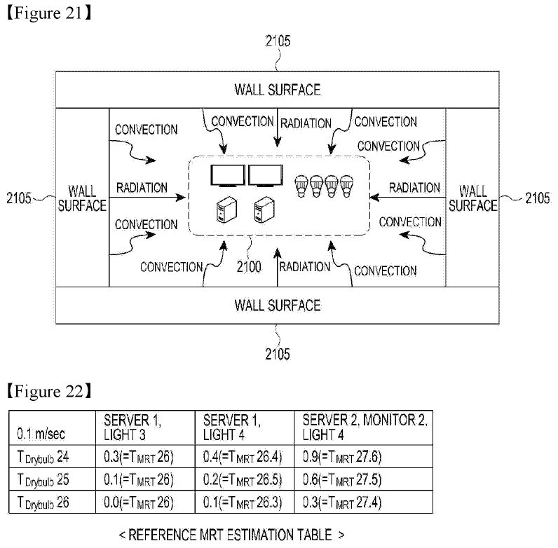

FIG. 21 is a view describing an operation for estimating an indoor MRT based on the presence of electronic devices according to an embodiment of the present disclosure.

As illustrated in FIG. 21, an MRT is also affected by the existence and number of electronic devices in a space. The server may receive information about the electronic devices existing in the space from a manager, read the information about the electronic devices existing in the space from a database in the storage that stores information about facilities in a building, sense the existence of the electronic devices directly or indirectly, or determine the existence and number of the electronic devices in the space to be controlled by a combination of at least two of the above methods. Information about the existence and number of the electronic devices may be stored in the reference MRT estimation table.

FIG. 22 illustrates an exemplary reference MRT estimation table including information about electronic devices according to an embodiment of the present disclosure.

Referring to FIG. 22, the illustrated reference MRT estimation table lists DBT measurements, and DBT variances for respective MRT measurements in a space with an air flow strength of 0.1 m/sec. The reference MRT estimation table further includes information about electronic devices in the measurement environment. For example, such information as ‘server 1, light 3’, ‘monitor 1, light 4’, and ‘server 2, monitor 2, light 4’ may be stored in the reference MRT estimation table. The server may estimate an MRT according to a DBT measurement, information about facilities in a space to be controlled, and a latest DBT variance during a unit time, based on the reference MRT estimation table.

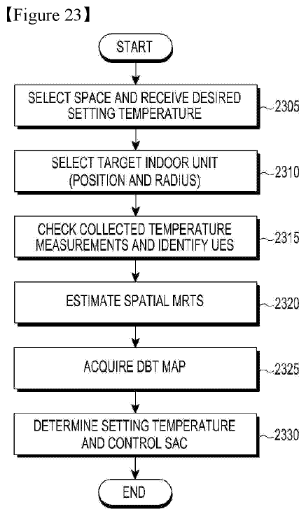

FIG. 23 is a flowchart illustrating an operation for determining a setting temperature in consideration of an MRT according to an embodiment of the present disclosure.

Referring to FIG. 23, the server selects a target space to be controlled, and receives a desired setting temperature for an indoor unit in operation 2305. The server identifies the indoor unit in the selected space in operation 2310, and reads information about temperature measurements collected in the space from the storage in operation 2315. Additionally, the server may read information about electronic devices in the space, or determine the types and number of the electronic devices in the space.

In operation 2320, the server estimates an MRT from the afore-described reference MRT estimation table, using the temperature measurements and/or the information about electronic devices. For example, the server may estimate the MRT according to the temperature measurements collected in the space, and variances of the temperature measurements during a latest time unit. For example, the server may estimate MRTs corresponding to the positions of the temperature measurements according to the temperature measurements collected in the space, the variances of the temperature measurements during the latest time unit, and the types and number of electronic devices in the space, and calculate relative values of the MRTs with respect to a reference MRT. The reference MRT may be, for example, the maximum of the MRTs. The server may generate a spatial MRT distribution map indicating the relative values of the estimated MRTs and positions corresponding to the relative values, and store the spatial MRT distribution map in the storage.

In operation 2325, the server reads a DBT correction map for the space from the storage.

In operation 2330, the server determines a setting temperature for the selected indoor unit by applying the DBT correction map to the desired setting temperature. The determined setting temperature may be stored by space in the storage of the server, and the server may transmit information about the determined setting temperature to the indoor unit.

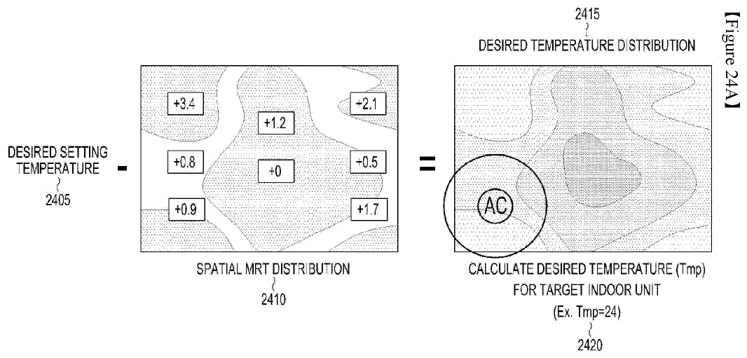

FIGS. 24A and 24B illustrate an example of determining a setting temperature by MRT estimation according to an embodiment of the present disclosure.

Referring to FIG. 24A, the server calculates a desired temperature distribution 2415 by subtracting per-position MRT relative values on a spatial MRT distribution map 2410 from a desired setting temperature 2405. The desired temperature distribution 2415 includes desired temperatures corresponding to positions in a target space to be controlled. The server may calculate a desired temperature Tmp 2420 corresponding to the position of a target indoor unit to be controlled, based on the desired temperatures included in the desired temperature distribution 2415. For example, the desired temperature Tmp 2420 may be calculated to be the average of the desired temperatures included in the desired temperature distribution 2415. For example, the server may calculate the desired temperature Tmp 2420 by interpolating a predetermined number of desired temperatures closest to the indoor unit according to distances to the indoor unit.

Referring to FIG. 24B, the server determines a setting temperature distribution map 2430 by subtracting per-zone correction values on a DBT correction map 2425 from the desired temperature Tmp 2420. The setting temperature distribution map 2430 indicates per-zone setting temperatures with respect to the position of the indoor unit. Then, a setting temperature for the indoor unit is finally calculated based on the per-zone setting temperatures.

In an embodiment, the setting temperature for the indoor unit may be calculated to be the average of the per-zone setting temperatures. In an embodiment, the server may finally calculate a setting temperature for the indoor unit in consideration of the areas of zones defined on the setting temperature distribution map 2430. In an embodiment, the server may calculate a setting temperature for the indoor unit directly (without the setting temperature distribution map) by applying an average correction value of the DBT correction map 2425 to the desired temperature 2420, instead of applying the individual correction values of the DBT correction map 2425 to the desired temperature 2420.

In the following embodiments, operations for normalizing feedbacks and determining per-individual thermal comfort ranges are provided. The per-individual thermal comfort ranges are per-individual thermal comfort information indicating temperature ranges in which individual users feel thermally comfortable, generated based on feedbacks collected from individual UEs. The following description is given of an operation for controlling an air conditioner in a space, in the case where a plurality of users are located in the same space.

FIG. 25 is a flowchart illustrating an operation for controlling an air conditioner using per-individual thermal comfort ranges according to an embodiment of the present disclosure.

Referring to FIG. 25, the server collects feedbacks from a plurality of UEs in a target building to be controlled in operation 2505. Each of the feedbacks may include a temperature measurement, thermal comfort information about a user, and position information about the user. In operation 2510, the server determines a per-individual thermal comfort range indicating a user-preferred operative temperature range for each of the UEs, and determines a preferred operative temperature based on the per-individual thermal comfort range. If wind is not blowing indoors, the operative temperature may be regarded as equal to the average of a temperature measurement and an MRT. The MRT may be set to a pre-measured value or estimated based on the afore-described reference MRT estimation table.

In an embodiment, the server may set an upper limit for a per-individual thermal comfort range using the first of feedback messages with thermal comfort information indicating dissatisfaction (hot) among a plurality of feedback messages received from the same UE. In an embodiment, the server may set a lower limit for a per-individual thermal comfort range using the first of feedback messages with thermal comfort information indicating dissatisfaction (cold) among a plurality of feedback messages received from the same UE. In an embodiment, the server may calculate a preferred operative temperature range based on temperature measurements collected from satisfaction feedbacks. Additionally, the server may calculate a non-preferred operative temperature range based on temperature measurements collected from dissatisfaction feedbacks.

In operation 2515, the server may determine a setting temperature for an indoor unit in the target space to be controlled based on the preferred/non-preferred operative temperature ranges of the plurality of UEs in the space, and transmit a temperature control command including the determined setting temperature to the indoor unit. In an embodiment, the server may determine the setting temperature to be between the upper and lower limits of at least one thermal comfort range.

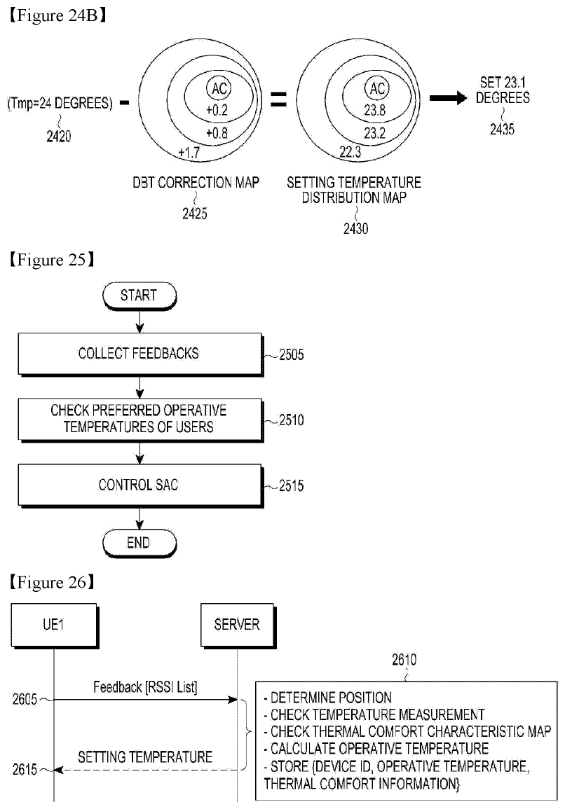

FIG. 26 is a flowchart illustrating an operation for extracting an individual thermal preference based on an operative temperature according to an embodiment of the present disclosure.

Referring to FIG. 26, UE1 transmits a feedback including at least one of position information, a temperature measurement, and thermal comfort information to a server in operation 2605. The position information may include, for example, an RSSI list. In operation 2610, the server determines the position of UE1 based on the RSSI list included in the feedback, acquires the temperature measurement from the feedback, determines a thermal comfort characteristic map corresponding to a space in which UE1 is located, and calculates a preferred operative temperature of UE1 by reflecting the feedback. Additionally, the server may store an ID of UE1, the calculated operative temperature, and the thermal comfort information for UE1. In operation 2615, the server notifies UE1 of the calculated operative temperature.

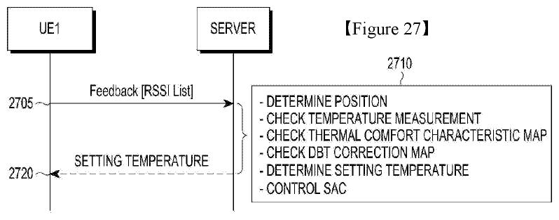

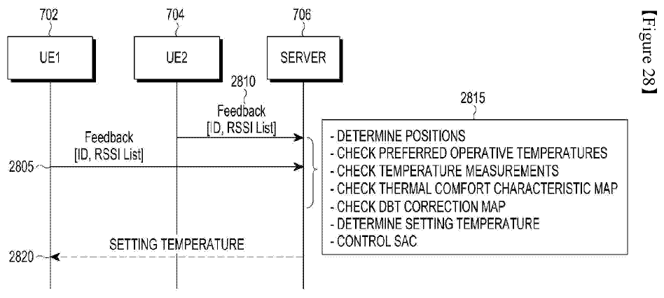

FIG. 27 is a flowchart illustrating an operation for controlling an air conditioner in consideration of a preferred operative temperature of a user according to an embodiment of the present disclosure.

Referring to FIG. 27, UE1 transmits a feedback to a server in operation 2705. The server determines the position of UE1 based on an RSSI list included in the feedback, acquires a temperature measurement from the feedback, reads a thermal comfort characteristic map and a DBT correction map for a space in which UE1 is located, determines a setting temperature for an indoor unit in the space based on the temperature measurement, the thermal comfort characteristic map, and the DBT correction map, and controls the indoor unit based on the setting temperature in operation 2710. To determine the setting temperature, the server may consider a pre-stored preferred operative temperature for UE1. In operation 2720 which is optional, the server may provide information about the determined setting temperature to UE1.

FIG. 28 is a flowchart illustrating an operation for controlling an air conditioner in consideration of preferred operative temperatures of a plurality of users according to an embodiment of the present disclosure.

Referring to FIG. 28, UE1 and UE2 transmit their feedbacks to a server in operations 2805 and 2810. In operation 2815, the server determines the positions and preferred operative temperatures of the UEs based on identification information and RSSI lists included in the received feedbacks. For example, the server may extract a representative temperature of the preferred operative temperatures of the plurality of UEs. The server checks temperature measurements included in the feedbacks, reads a thermal comfort characteristic map and a DBT correction map for the space, determines a setting temperature for an indoor unit in the space based on the temperature measurements, the thermal comfort characteristic map, and the DBT correction map, and controls the indoor unit based on the setting temperature in operation 2815. To determine the setting temperature, the server may consider the determined representative operative temperature. In optional operation 2820, the server may provide information about the determined setting temperature to UE1.

In an embodiment, the server may determine the setting temperature in such a manner that as many preferred operative temperatures of users as possible may be reflected and as few non-preferred operative temperatures of users as possible may be reflected, for control of an air conditioner in the space where the plurality of users are located. In an embodiment, the feedbacks received in operation 2805 and 2810 may further include user priority information about the UEs. User priority information about a UE may include information about the gender, age, characteristics (pregnancy/disease/job position) of a user. The server may assign weights to users with priority, for example, a Very Important Person (VIP), the old and weak, a child, and the pregnant based on the user priority information about the plurality of UEs.

In the following embodiments, the server may determine a cooling/heating time based on the upper and lower limits of temperature measurements that define a thermal comfort range.

In an embodiment, upon receipt of a plurality of feedback messages including thermal comfort information indicating dissatisfaction (hot) from one UE in a specific space, the server may initially set or reset an upper limit for a thermal comfort range, using the first of the received feedback messages. In an embodiment, upon receipt of a plurality of feedback messages including thermal comfort information indicating dissatisfaction (cold) from one UE in a specific space, the server may initially set or reset a lower limit for a thermal comfort range, using the first of the received feedback messages.

In an embodiment, if a temperature measurement collected by an indoor unit in a target space to be controlled falls within a thermal comfort range being a predetermined temperature range in which users feel thermally comfortable, the indoor unit may maintain a current operation (cooling or heating) for a predetermined minimum required time. This is because if the indoor unit is running at a high temperature in the thermal comfort range, overcooling or overheating may occur. Likewise, if the indoor unit is off at a low temperature in the thermal comfort range, users may feel uncomfortable.

In an embodiment, if the server detects that a temperature measurement is higher than the upper limit of the thermal comfort range a predetermined unit time+a time delay after determining that a temperature measurement is within the thermal comfort range, the server may perform cooling for a minimum required time. In an embodiment, if the server detects that a temperature measurement is lower than the lower limit of the thermal comfort range a predetermined unit time+a time delay after determining that a temperature measurement is within the thermal comfort range, the server may perform heating for a minimum required time. The time delay may be set in consideration of, for example, the performance, capacity, thermal inertia, and heat transfer delay of an indoor unit installed in each space.

From a specific aspect, various embodiments of the present disclosure can be implemented as computer-readable code in a computer-readable recoding medium. The computer-readable recoding medium is a data storage device capable of storing data readable by a computer system. Examples of the computer-readable recoding medium include read only memory (ROM), random access memory (RAM), compact disk read only memory (CD-ROM), magnetic tapes, floppy disks, optical data storage devices, and carrier waves (data transmission over the Internet). The computer-readable recoding medium may be distributed to networked computer systems, and thus the computer-readable code is stored and executed in a distributed manner. Further, skilled programmers in the art may easily interpret functional programs, code, and code segments constructed to achieve various embodiments of the present disclosure.

The apparatus and method according to various embodiments of the present disclosure can be implemented in hardware, software, or a combination thereof. The software may be stored in a volatile or non-volatile storage device such as ROM irrespective of erasable or rewritable, a memory such as RAM, a memory chip, a device, or an integrated circuit (IC), or an optically or magnetically writable and machine-readable (for example, computer-readable) storage medium such as CD, DVD, a magnetic disk, or a magnetic tape. The method according to various embodiments of the present disclosure can be performed by a computer or portable terminal including a controller and a memory, and the memory is an exemplary machine-readable storage medium suitable for storing a program or programs containing instructions that implement the embodiments of the present disclosure.

Accordingly, the embodiments of the present disclosure include a program with a code that implements an apparatus or method disclosed in the claims, and a machine-readable (computer-readable or the like) storage medium storing the program. This program may be electronically transferred on a medium such as a communication signal transmitted via a wired or wireless connection, and the embodiments of the present disclosure appropriately include the equivalents.

In addition, the apparatus according to various embodiments of the present disclosure may receive and store a program from a wiredly or wirelessly connected program providing device. The program providing device may include a program containing instructions that control a program processor to perform a predetermined content protection method, a memory for storing information required for the content protection method, a communication unit for conducting wired or wireless communication with a graphic processor, and a controller for transmitting the program to a transceiver upon request of the graphic processor or automatically.

The embodiments of the present disclosure described and illustrated in the specification and the drawings are mere examples provided to easily describe the technology of the present disclosure and help understanding of the embodiments of the present disclosure, not limiting the scope of the present disclosure. The foregoing embodiments of the present disclosure are purely exemplary and those skilled in the art will understand that various modifications can be made and equivalent embodiments can be implemented. Accordingly, the true scope of the present disclosure should be defined by the appended claims.

1. A method for controlling an air conditioner, the method comprising:
generating a dry bulb temperature (DBT) correction map for a space, based on feedback messages received from a plurality of user equipments (UEs);
generating a thermal comfort characteristic map for the space, based on temperature measurements included in the feedback messages;
determining a setting temperature for the air conditioner in the space, based on the DBT correction map and the thermal comfort characteristic map; and
controlling the air conditioner to the determined setting temperature.

2. The method of claim 1,
wherein each of the feedback messages includes position information about a UE corresponding to the feedback message, and
wherein the position information is acquired using received signal strengths of a plurality of wireless signals received from a plurality of network nodes by the UE.

3. The method of claim 2, wherein the generation of a DBT correction map comprises:
checking the position information about the UEs and the temperature measurements included in the feedback messages;
generating a DBT distribution table indicating per-position temperature measurements based on the position information and the temperature measurements;
checking a temperature measurement received from the air conditioner nearest to the UEs; and
generating the DBT correction map based on differences between the temperature measurements included in the DBT distribution table and the temperature measurement received from the air conditioner, and positions corresponding to the temperature measurements.

4. The method of claim 3, wherein the generation of a DBT correction map comprises:
defining a plurality of zones according to predetermined radiuses from a position of the air conditioner; and
determining per-zone DBT correction values, each being a difference between an average of a temperature measurement included in a feedback message received from at least one UE in a zone and the temperature measurement received from the air conditioner.

5. The method of claim 4, wherein the generation of a DBT correction map comprises:
classifying the feedback messages according to reception times; and
generating an independent per-time zone DBT correction map for each time zone based on position information and temperature measurements included in feedback messages received at times of the same time zone.

6. The method of claim 2, wherein the generation of a thermal comfort characteristic map comprises:
calculating per-position correction temperatures based on thermal comfort information, the position information, and the temperature measurements included in the feedback messages; and
storing the per-position correction temperatures along with space information.

7. The method of claim 6,
wherein the calculation of per-position correction temperatures comprises:
calculating an average of temperature measurements within a predetermined distance based on the position information included in the feedback messages, as a correction temperature corresponding to the position information, and determining centroid coordinates of the position information corresponding to the temperature measurements within the predetermined distance to be a position corresponding to the calculated correction temperature, and
wherein the predetermined distance is determined based on an installation interval between a plurality of air conditioners in a system including the air conditioner.

8. The method of claim 6,
wherein the per-position correction temperatures are calculated based on temperature measurements included in feedback messages including the same thermal comfort information, and
wherein the same thermal comfort information indicates one of satisfaction, cold dissatisfaction, and hot dissatisfaction.

9. The method of claim 8, wherein if thermal comfort information indicating one of cold dissatisfaction and hot dissatisfaction is used, the per-position correction temperatures are calculated based on thermal comfort information included in a first of a plurality of feedback messages received from the same UE.

10. The method of claim 9, further comprising:
determining an upper limit for a thermal comfort range based on a first message including thermal comfort information indicating hot dissatisfaction among a plurality of feedback messages received from the same UE;
determining a lower limit for the thermal comfort range based on a first message including thermal comfort information indicating cold dissatisfaction among a plurality of feedback messages received from the same UE; and
controlling the air conditioner using the thermal comfort range,
wherein the setting temperature for the air conditioner is determined to be a value between the upper and lower limits of the thermal comfort range.

11. (canceled)

12. A server capable of controlling an air conditioner, the server comprising:
a communication unit;
a controller configured to:
receive, through the communication unit, feedback messages from a plurality of user equipments (UEs), each feedback message including at least one of position information, a temperature measurement, and thermal comfort information;
generate a dry bulb temperature (DBT) correction map for a space, based on the feedback messages received from the plurality of user equipments;
generate a thermal comfort characteristic map for the space, based on temperature measurements included in the feedback messages;
determine a setting temperature for the air conditioner in the space, based on the DBT correction map and the thermal comfort characteristic map; and
control the air conditioner to the determined setting temperature, and transmitting to the air conditioner information about a setting temperature to control the air conditioner.

13. A method for requesting control of an air conditioner by a user equipment (UE), the method comprising:
determining position information about a current position of the UE based on received signal strengths of wireless signals received from a plurality of network nodes;
acquiring a temperature measurement at the current position through a temperature sensor;
receiving thermal comfort information about a user through an input unit;
generating a feedback message including the position information, the temperature measurement, and the thermal comfort information; and
transmitting the generated feedback message to a server for controlling the air conditioner to control a temperature of a space in which the UE is located.

14. The method of claim 13, wherein the feedback message is generated and transmitted to the server periodically in every predetermined period.

15. The method of claim 14, further comprising:
in the absence of thermal comfort information about the user received through the input unit within a predetermined time, generating a feedback message including the position information and the temperature measurement without the thermal comfort information, and transmitting the feedback message to the server.

16. The method of claim 14, further comprising:
in the absence of thermal comfort information about the user received through the input unit within a predetermined time, generating thermal comfort information indicating satisfaction; and
generating a feedback message including the position information, the temperature measurement, and the generated thermal comfort information, and transmitting the feedback message to the server.

17. The method of claim 15, wherein the feedback message further includes user priority information about the UE.

18. The method of claim 13, further comprising receiving information about a dry bulb temperature (DBT) correction map generated based on the feedback message from the server, after transmitting the generated feedback message to the sever.

19. The method of claim 18, further comprising receiving information about a thermal comfort characteristic map generated based on the feedback message from the server.

20. The method of claim 19, further comprising receiving information about a thermal comfort range generated based on the feedback message from the server.

21. A user equipment (UE) for requesting control of an air conditioner, the UE comprising:
a sensor unit for acquiring a temperature measurement at a current position;
an input unit for receiving thermal comfort information about a user;
a controller for determining position information about the current position of the UE, generating a feedback message including the position information, the temperature measurement, and the thermal comfort information; and
a communication unit for transmitting the feedback message to a server for controlling the air conditioner to control a temperature of a space in which the UE is located.
